(19) United States
(12) Patent Application Publication
(10) Pub. No.: US 2024/0403378 A1
(43) Pub. Date: Dec. 5, 2024

(54) DATA ACQUISITION TOOL AND SYSTEM AND METHOD FOR DATA ACQUISITION

(71) Applicant: 10353744 Canada Ltd., Kitchener (CA)

(72) Inventors: Mark Church, Waterloo (CA); Zachary Packull, Cambridge (CA)

(21) Appl. No.: 18/734,422

(22) Filed: Jun. 5, 2024

Related U.S. Application Data
(60) Provisional application No. 63/506,253, filed on Jun. 5, 2023.

(51) Int. Cl. G06F 16/954; G06F 16/29; G06F 16/955

(52) U.S. Cl. CPC G06F 16/954; G06F 16/29; G06F 16/9558

(57) ABSTRACT

Provided are systems and methods for acquiring data hosted on a server and updating acquired data. The system includes an acquisition module for acquiring the data from one or more linked pages each linked to from a main page by an event link by following each event link, the acquisition module including a selection module for selecting one or more event data hosted on the linked page by selecting an element on the linked page and storing path data corresponding to the selected element, a mapping module for classifying a type for each event datum, a navigation module for navigating a navigation structure of each linked page to vary a selection of each element, and a storing module for storing the event links and the event data. The system further includes an updating module for updating the event data according to the stored path data.

### TECHNICAL FIELD

The following relates generally to data acquisition, and more particularly to acquiring data from a webpage or the like through screen-scraping.

### INTRODUCTION

Events and details thereon are often hosted on webpages accessible through the Internet. Such webpages hosting events and details thereon may themselves be linked to or otherwise accessible from listing or main pages that list series of events and links thereto.

The varied nature of such events in terms of formatting on the webpages, the multiplicity of events offered by even a single provider, and the temporality of such events in being subject to change until the events occur and the details thereon being expired after the events occur present an obstacle that conventional systems, methods, and devices for acquiring data do not overcome.

Accordingly, there is a need for improved systems, methods, and devices for acquiring data from a webpage or the like and updating such acquired information that overcome at least some of the disadvantages of existing systems, methods, and devices.

### SUMMARY

A computer system for acquiring structured data hosted on a server is provided. The system includes an acquisition module for acquiring the structured data from one or more linked pages each linked to from a main page by a page link by following each page link the acquisition module including a selection module for selecting one or more structured data hosted on the linked page by selecting an element on the linked page and storing path data corresponding to the selected element, a mapping module for classifying a type for each structured datum, a navigation module for navigating a navigation structure of each linked page to vary a selection of each element, and a storing module for storing the page links and the structured data, and an updating module for updating the structured data according to the stored path data.

The structured data may be event data pertaining to one or more events having a definite time, duration, or place.

The selection module may receive selector data to navigate the linked page.

The acquisition module may acquire the data through screen-scraping.

The screen-scraping may includes opening up a plurality of headless browser instances lacking a user interface, each headless browser instance configured to navigate to a page link, load the page linked by the page link, and use the selector data to obtain the event data.

The updating module may not update the structured data where the structured data has not changed.

Each event datum may correspond to an event and may include at least one of a title of the event, a description of the event, and a date or time of the event, and the page link, and the path data may store a path on the linked page for the title of the event, the description of the event, the date or time of the event, and/or the event link.

The structured data of the one or more linked pages may include HTML data stored in a plurality of formats or organizational structures, and the storing module may store the structured HTML data according to a uniform database format.

A computer-implemented method for acquiring structured data hosted on a server is provided, the method including receiving a first link to a main page, the main page including one or more page links, for each page link, following the page link to a linked page, for each linked page, selecting one or more of the structured data hosted on the linked page by selecting an element on the linked page, for each selected structured datum, storing corresponding path data, classifying a type for each structured datum, indicating that the element has been correctly selected, and storing the structured data.

The method may further include scraping the main page by opening up a plurality of headless browser instances, each headless browser instance navigating to a respective page link and loading the respective linked page.

The structured data may be event data pertaining to one or more events having a definite time, duration, or place.

The structured data of the one or more linked pages may include HTML data stored in a plurality of formats or organizational structures, and storing the structured data may include storing the structured HTML data according to a uniform database format.

A computer-implemented method for updating previously acquired structured data hosted on a server is provided, the method including determining to update one or more of the previously acquired structured data, each previously acquired structured data having been acquired via following a corresponding page link on a main page to a linked page, following each corresponding page link, reacquiring each previously acquired structured datum according to path data previously associated with an element on the linked page, the element having been previously selected as the structured datum, automatically deleting each previously acquired structured datum for which there is no element on the linked page corresponding to the element previously selected as the structured datum, and indicating which data were updated.

The method may further include scraping the main page by opening up a plurality of headless browser instances, each headless browser instance navigating to a respective event link and loading the respective linked page.

The structured data may be event data pertaining to one or more events having a definite time, duration, or place.

Determining to update the one or more of the previously acquired structured data may be performed according to received user input.

Determining to update the one or more of the previously acquired structured data may be performed automatically.

The method may further include providing a log for recording which data were deleted, which data were updated, and which data were not deleted or updated.

The one or more previously acquired structured data may be updated only if the one or more previously acquired structured data has changed.

The structured data of the one or more linked pages may include HTML data stored in a plurality of formats or organizational structures, and reacquiring each previously acquired structured datum may include storing the structured HTML data according to a uniform database format.

A computer system for acquiring data hosted on a server is provided. The system includes an acquisition module for acquiring the data from one or more linked pages each linked to from a main page by an event link by following each event link. The acquisition module includes a selection module for selecting one or more event data hosted on the linked page by selecting an element on the linked page and storing path data corresponding to the selected element, a mapping module for classifying a type for each event datum, a navigation module for navigating a navigation structure of each linked page to vary a selection of each element, and a storing module for storing the event links and the event data. The system includes an updating module for updating the event data according to the stored path data.

The selection module may receive selector data to navigate the linked page.

The acquisition module may acquire the data through screen-scraping.

The screen-scraping may include opening up a plurality of headless browser instances lacking a user interface. Each headless browser instance may be configured to navigate to an event link, load the page linked by the event link, and use the selector data to obtain the event data.

The updating module may update the event data according to a recurring time period.

The updating module may update the event data according to a received command.

The system may be a plug-in deployed on a browser operating on a user device or on the server and built locally in the browser.

Each event datum corresponding to an event may include at least one of a title of the event, a description of the event, and a date or time of the event, and the event link.

The path data may store a path on the linked page for the title of the event, the description of the event, the date or time of the event, and/or the event link.

The navigation structure may be a stack.

The path data may be modifiable after being selected.

Each event link may correspond to a single event. Each event may correspond to a single event link.

Each event link may link to multiple events. Each event may correspond to a single event link.

Each event link may correspond to a single event. Each event may correspond to multiple event links.

Each event link may corresponds to multiple events. Each event may correspond to multiple event links.

A computer-implemented method for acquiring data hosted on a server is provided. The method includes receiving a first link to a main page, the main page including one or more event links. The method further includes, for each event link, following the event link to a linked page. The method further includes, for each linked page, selecting one or more event data hosted on the linked page by selecting an element on the linked page. The method further includes, for each selected event datum, storing corresponding path data. The method further includes classifying a type for each event datum, indicating that the element has been correctly selected, and storing the event data.

Selecting the one or more event data may include allowing the user to manually select an element on the page through the use of a selector.

Selecting the one or more event data may include receiving user input for navigating a navigation structure of the linked page.

Classifying a type for each event datum may include receiving user input as to what type of event data a selected element on the page corresponds to.

Indicating that the element has been correctly selected may include receiving user input that the element has been correctly selected.

The user input may include clicking a button on the linked page.

Selecting the one or more event data may include selecting and modifying path data by manually modifying or typing the path data.

A computer-implemented method for updating previously acquired data hosted on a server is provided. The method includes determining to update one or more of the previously acquired data, each previously acquired data having been acquired via following a corresponding event link on a main page, following each corresponding event link, reacquiring each previously acquired datum according to path data previously associated with an element on the linked page, the element having been previously selected as the event datum, automatically deleting each previously acquired datum for which there is no element on the linked page corresponding to the element previously selected as the event datum, and indicating which data were updated.

Determining to update the one or more of the previously acquired data may be performed according to received user input.

Determining to update the one or more of the previously acquired data may be performed automatically.

The method may further include providing a log for recording which data were deleted, which data were updated, and which data were not deleted or updated.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram illustrating a system for acquiring data from a web page, according to an embodiment;

FIG. 2 is a block diagram of components of a mobile device or portable electronic device, according to an embodiment;

FIG. 3 is a block diagram of a computer system for acquiring data, according to an embodiment;

FIG. 4 is a flow chart of a method of acquiring data from a web page, according to an embodiment;

FIG. 5 is a flow chart of a method of updating previously acquired data, according to an embodiment;

FIG. 6 is a view of a webpage during selection of an element;

FIG. 7 is another view of a webpage during selection of an element;

FIG. 8 is another view of a webpage during selection of an element;

FIG. 9 is another view of a webpage during selection of an element, the navigation structure being visible;

FIG. 10 is another view of a webpage during selection of an element, the navigation structure being visible;

FIG. 11 is a view of a webpage where path data corresponding to event data is modified;

FIG. 12 is a view of a webpage where selection of an element is being edited by modifying path data;

FIG. 13 is a view of a webpage where selected elements are being mapped; and

FIG. 14 is a log of the results of attempting to update previously acquired data.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistant, cellular telephone, smartphone, or tablet device.

Each program is preferably implemented in a high level procedural or object-oriented programming and/or scripting language to communicate with a computer system. However, the programs can be implemented in assembly or machine language, if desired. In any case, the language may be a compiled or interpreted language. Each such computer program is preferably stored on a storage medium or a device readable by a general or special purpose programmable computer for configuring and operating the computer when the storage medium or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present disclosure relates to data acquisition and updating for structured data. A preferred embodiment of the present disclosure relates to data acquisition and updating for event data, i.e., where the structured data is or includes event data. The present disclosure expressly includes data acquisition and updating for contexts other than event data, e.g., HTML data more generally.

Although the present disclosure is described in the context of events and calendars, these examples are non-limiting. The present disclosure is applicable to any data existing on a webpage for which a selector may be described, e.g., where an initial list includes links to more detailed pages corresponding to each item. For example, the present disclosure may be applicable in the field of patent prior art searching.

For example, the present disclosure may be applicable to large datasets or corpora for language model learning. Such large datasets or corpora may be considered labelled data sets with associated metadata. The present invention may, in the context of such large datasets or corpora, provide a structured interpretation of wild data to generate datasets used to train artificial intelligence models for machine learning. The present invention may further provide functionality with respect to demographic data for population modeling, interpreting incoming data streams in the Internet of Things, and auditing financial statement of a large company.

The present invention is suitable for use with dynamic data that may be updated or refreshed from time to time and may flag or provide notifications when such updates or refreshes occur. The present invention is suitable for use with static data that may not be updated or refreshed from time to time. The present invention is suitable for use with both dynamic and static data at once.

Throughout the present disclosure, reference is made to event data or applications of the present disclosure in the context of data acquisition with respect to events. It will be understood that, while event data and data acquisition with respect to events represent preferred embodiments of the present disclosure, the systems, methods, and devices as herein disclosed relate broadly to structured hierarchical data and data acquisition with respect to structured hierarchical data, of which event data and data acquisition with respect to events are examples, respectively. The present disclosure expressly contemplates other contexts for structured hierarchical data other than event data. Such structured hierarchical data may include any data organized as a list where each element thereof references or links to further details (e.g., a list on a first webpage where each element in the list links to a different webpage). An example of such structured hierarchical data is search results returned in a prior art search to determine patentability.

The present disclosure further expressly contemplates providing a payments engine coupled with the foregoing structured hierarchical data functionality. Such an inventive combination of the structured hierarchical data functionality, coupled with a payments engine, may be used, for example, to acquire available event data and enable payments processing with respect to events, e.g., registration therefor.

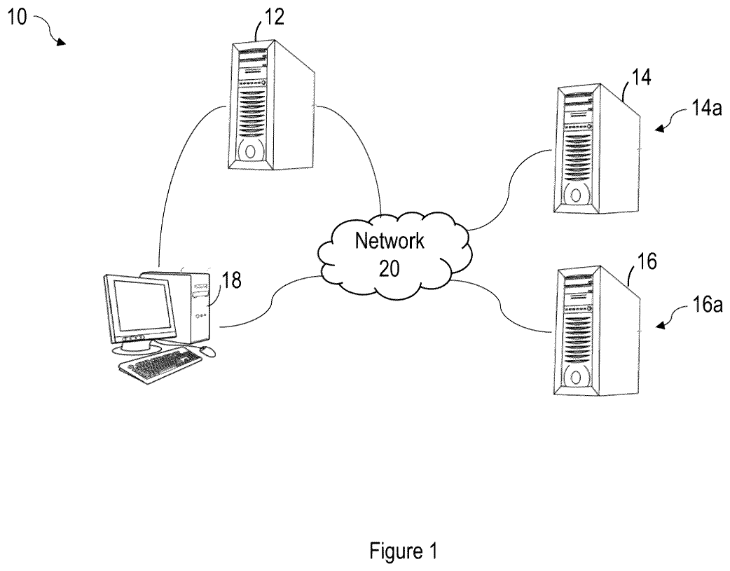

Referring now to FIG. 1, shown therein is a block diagram illustrating a system 10 for acquiring data from a web page, in accordance with an embodiment. The system 10 includes an acquiring server platform 12 which communicates with a plurality of hosting server platforms 14 and 16 via a network 20. The server platform 12 may be a purpose-built machine designed specifically for data acquisition via screen scraping. The system 10 further includes a user device 18 for communicating with the acquiring server platform 12. The user device 18 may communicate with the acquiring server platform 12 directly or via the network 20. The user device 18 provides instructions for data acquisition to the acquiring server platform 12. The user device 18 may receive information from the acquiring server platform 12, for example, results of data acquisition via screen scraping.

The server platform 12 acquires data from websites 14a, 16a hosted at hosting server platforms 14 and 16, respectively. The hosting server platforms 14 and 16 may host a variety of websites, the data of each of which may be acquired by the server platform 12.

Acquiring data from the websites 14a, 16a includes acquiring data on events from the websites 14a, 16a. For example, where the website 14a includes a list of events hosted by an organizer or taking place at a particular venue, the server platform 12, automatically or in response to a command from the user device 18, acquires all data on each of the events listed on the website 14a. The server platform 12 may acquire all the data on the events available from the website 14a. The server platform 12 may acquire only that data on the events available from the website 14a that is compatible with tables, forms, or other formatting previously configured at the server platform 12. Such configuration may be in respect of the website 14a alone and may be different from the configuration of the server platform 12 in respect of the website 16a. Such configuration may be applied to all websites 14a, 16a whose data is acquired by the server platform 12. The server platform 12 may acquire only the data specified in commands received from the user device 18. The server platform 12 may acquire all data except the data specified in commands received from the user device 18.

Where the server platform 12 has already acquired all data on each of the events listed on the website 14a, the server platform 12, automatically or in response to a command from the user device 18, updates all the data on the events available from the website 14a. In an embodiment, the server platform 12 only updates data previously acquired with respect to the events whose data was previously acquired. In an embodiment, the server platform 12 acquires all data with respect to the events previously acquired, whether or not a particular kind of data was previously acquired. The server platform 12 may acquire only that data on the events available from the website 14a that is compatible with tables, forms, or other formatting previously configured at the server platform 12. In an embodiment, updating includes acquiring data on new events whose data was not previously acquired. The server platform 12 may update only the data specified in commands received from the user device 18. The server platform 12 may update all data except the data specified in commands received from the user device 18.

The acquired data pertaining to events listed on the webpages 14a, 16a is stored at the server platform 12. The acquired data stored at the server platform 12 may be stored in any suitable configuration.

The server platforms 12, 14, 16 and user device 18 may be a server computer, desktop computer, notebook computer, tablet, PDA, smartphone, or another computing device. The server platforms 12, 14, 16 and user device 18 may include a connection with the network 20 such as a wired or wireless connection to the Internet. In some cases, the network 20 may include other types of computer or telecommunication networks. The server platforms 12, 14, 16 and user device 18 may include one or more of a memory, a secondary storage device, a processor, an input device, a display device, and an output device. Memory may include random access memory (RAM) or similar types of memory. Also, memory may store one or more applications for execution by a processor. Applications may correspond with software modules comprising computer executable instructions to perform processing for the functions described below. The secondary storage device may include a hard disk drive, floppy disk drive, CD drive, DVD drive, Blu-ray drive, or other types of non-volatile data storage. The processor may execute applications, computer-readable instructions, or programs. The applications, computer-readable instructions, or programs may be stored in memory or in secondary storage or may be received from the Internet or other network 20. The input device may include any device for entering information into the server platforms 12, 14, 16 and user device 18. For example, the input device may be a keyboard, key pad, cursor-control device, touch-screen, camera, or microphone. The display device may include any type of device for presenting visual information. For example, the display device may be a computer monitor, a flat-screen display, a projector or a display panel. The output device may include any type of device for presenting a hard copy of information, such as a printer for example. The output device may also include other types of output devices such as speakers, for example. In some cases, the server platforms 12, 14, 16 and user device 18 may include multiple of any one or more of processors, applications, software modules, secondary storage devices, network connections, input devices, output devices, and display devices.

Although the server platforms 12, 14, 16 and user device 18 are described with various components, the server platforms 12, 14, 16 and user device 18 may in some cases include fewer, additional or different components. In addition, although aspects of an implementation of the server platforms 12, 14, 16 and user device 18 may be described as being stored in memory, these aspects may also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the server platforms 12, 14, 16 and user device 18 and/or processor to perform a particular method.

In the description that follows, devices such as the server platforms 12, 14, 16 and user device 18 are described performing certain acts. It will be appreciated that any one or more of these devices may perform an act automatically or in response to an interaction by a user of that device. That is, the user of the device may manipulate one or more input devices (e.g., a touchscreen, a mouse, a button) causing the device to perform the described act. In many cases, this aspect may not be described below, but it will be understood.

As an example, it is described below that the server platform 12 may send information to the server platforms 14, 16, e.g., data associated with viewing the websites 14a, 16a, respectively. For example, a user using the user device 18 may manipulate one or more input devices (e.g. a mouse and a keyboard) to interact with a user interface displayed on a display of the user device 18, e.g., to control the data acquisition of the server platform 12. Generally, the user device 18 may receive a user interface from the network 20 (e.g., in the form of a webpage). Alternatively or in addition, a user interface may be stored locally at the user device 18 (e.g., a cache of a webpage or a mobile application).

The user device 18 may be configured to receive a plurality of data from the server platform 12 in respect of the webpages 14a, 16a. Generally, the information may comprise at least a database of data acquired or information for accessing such a database as stored on the server platform 12.

Upon or after acquiring the data in respect of the webpages 14a, 16a, the server platform 12 may store the data in a storage database. The storage database may correspond with secondary storage of the server platforms 12, 14, 16 or the device 18. Generally, the storage database may be any suitable storage device such as a hard disk drive, a solid-state drive, a memory card, or a disk (e.g., CD, DVD, Blu-ray). Also, the storage database may be locally connected with the server platform 12. In some cases, the storage database may be located remotely from the server platform 12 and accessible to the server platform 12 across a network, for example. In some cases, the storage database may comprise one or more storage devices located at a networked cloud storage provider.

The user device 18 may be associated with one or more user accounts. Any suitable mechanism for associating the user device 18 with an account is expressly contemplated. In some cases, the user device 18 may be associated with an account by sending credentials (e.g., a cookie, login, password) to the server platform 12. The server platform 12 may verify the credentials (e.g., determine that the received password matches a password associated with the account). If the user device 18 is associated with an account, the server platform 12 may consider further acts by the user device 18 to be associated with that account.

In an embodiment, the user device 18 is associated with multiple user accounts at a time. Actions performed or requested by a particular user account may not affect other user accounts.

In an embodiment, the user device 18 is associated with only a single user account at a time. In an embodiment, the user device 18 is disassociated from a user account by the actions of that user, of a different user, of an administrator, or otherwise. Actions performed by a particular user account may not affect other user accounts.

It will be appreciated that not all of the components of the system 10 are necessary for acquiring data. In an embodiment, no server platform 12 is present, and all data acquisition functions with respect to the websites 14a, 16a are performed locally at the server platforms 14, 16, respectively.

In an embodiment, the server platform 12 is a plug-in or extension of a web browser on the user device 18. The plug-in or extension may be an extension for a web browser, e.g., Google Chrome™, Microsoft Edge™. The plug-in or extension may be an extension compatible with or suitable for download or configuration onto any other type of web browsing software. The plug-in or extension may be an extension compatible with or suitable for download or configuration onto any application or program suitable for viewing event information, e.g., a browser for viewing an Intranet of an organization.

In an embodiment, the plug-in or extension is built locally as code and deployed to the browser or other suitable application or program.

Although the foregoing disclosure has been described in the context of event information, the foregoing disclosure has other applications in other areas of endeavour. Accordingly, the present disclosure is not limited to the context of event information and acquiring data via screen scraping in the context of event information, and other such contexts and areas of endeavour are expressly and explicitly contemplated herein.

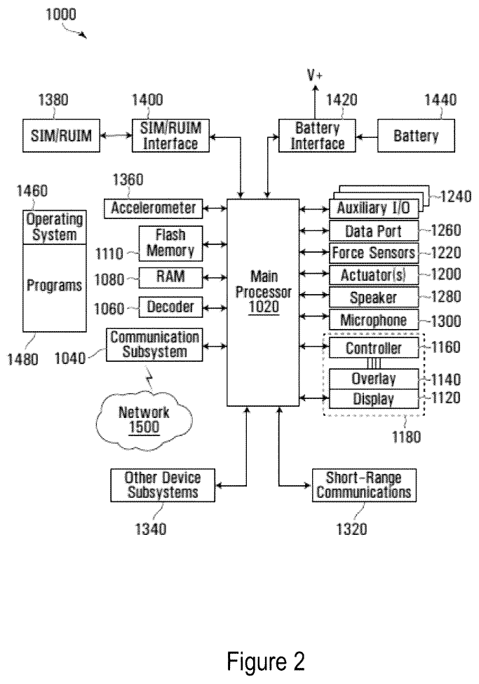

Referring now to FIG. 2, shown therein is a simplified block diagram of components of a mobile device or portable electronic device 1000, according to an embodiment. The portable electronic device 1000 includes multiple components such as a processor 1020 that controls the operations of the portable electronic device 1000. Communication functions, including data communications, voice communications, or both may be performed through a communication subsystem 1040. Data received by the portable electronic device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The portable electronic device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the portable electronic device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The portable electronic device 1000 also includes an operating system 1460 and software components 1480 that are executed by the processor 1020 and which may be stored in a persistent data storage device such as the flash memory 1110. Additional applications may be loaded onto the portable electronic device 1000 through the wireless network 1500, the auxiliary 1/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary 1/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

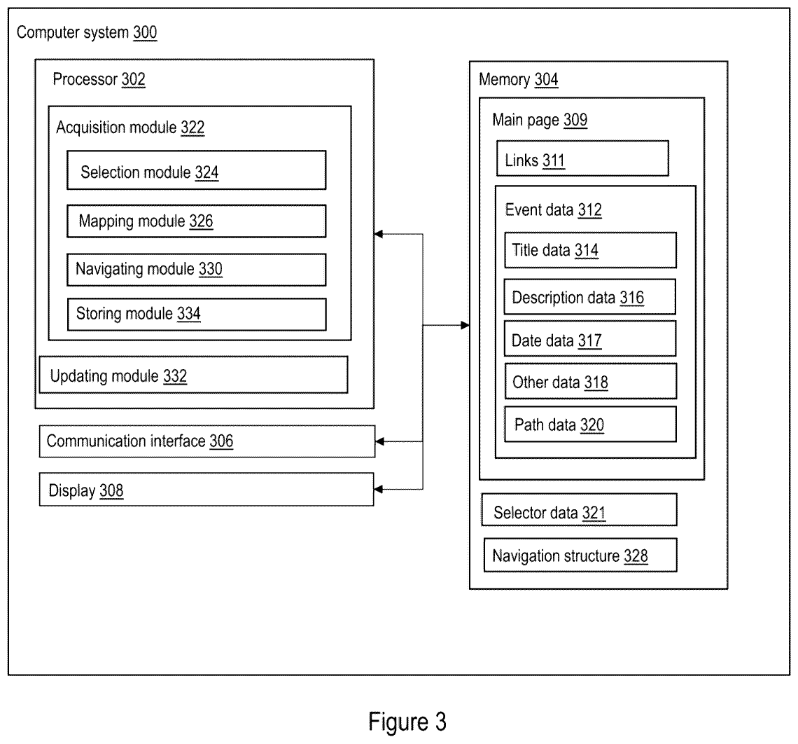

Referring now to FIG. 3, shown therein is a block diagram of a computer system 300 for acquiring data, according to an embodiment. The computer system 300 may be implemented at one or more devices of the system 10 of FIG. 1. For example, some or all of the components of the computer system 300 may be implemented by any one or more of the server platforms 12, 14, 16, and the user device 18.

The system 300 includes a processor 302 for executing software models and modules.

The system 300 further includes a memory 304 for storing data, including output data from the processor 302.

The system 300 further includes a communication interface 306 for communicating with other devices, such as through receiving and sending data via a network connection (e.g., network 20 of FIG. 1)

The system 300 further includes a display 308 for displaying various data generated by the computer system 300 in human-readable format. For example, the display may be configured to display events and data thereon acquired from websites hosted by the hosting servers 14, 16.

The processor 302 includes an acquisition module 322 for acquiring data. Data acquired by the acquisition module is stored as event data 312 in the memory 304.

The memory 304 includes main page 309. The main page 309 corresponds to a web page hosting data on events. The main page 309 includes links 311 to a variety of events (collectively the links 311 and generically a link 311). In an embodiment, each link 311 on the main page 309 links to an individual event in a bijective fashion and corresponds to one instance of the event data 312 in a bijective fashion. In an embodiment, each link on the main page 309 links to more than one event and corresponds to more than one instance of the event data 312. For example, each link 311 may link to multiple events, but each event may only be accessible through one link. For example, each link 311 may link to multiple events, and each event may be accessible through more than one link. The main page 309 may include any number of links 311. For example, each link 311 may link to multiple events, and each event may be accessible through multiple links 311. All embodiments wherein each event is accessible through one or more links 311, each of which may link to one or more events, are expressly contemplated.

The event data 312 corresponds to data on a particular event. In an embodiment, all or some of the event data 312 in respect of a particular event may only be acquirable through the corresponding link(s) 311. In an embodiment, all or some of the event data 312 in respect of the particular event may be acquirable without resort to the corresponding link(s) 311. Further and/or better information may be available through the corresponding link(s) 311.

The event data 312 includes title data 314, for example the title of the particular event.

The event data 312 further includes description data 316, for example a description of the particular event.

The event data 312 further includes date data 317, for example a specific date and/or time of an event.

The event data 312 further includes other data 318, for example optional or additional information concerning the particular event. A user of the computer system 300 may configure the computer system 300 to include or exclude the other data 318 from the event data 312.

The event data 312 further includes path data 320 for storing a path of all other data in the event data 312. In an embodiment, the path data 320 stores the path of each of the title data 314, the description data 316, the date data 317, and the other data 318.

The acquisition module 322 includes a selection module 324 for selecting event data 312 hosted on the main page 309 or on a page linked to by a link 311. In an embodiment, the selection module 324 allows a user to manually select an element on the page through the use of a selector (not shown). The information inputted by the user to the selector (e.g., a click) is stored in the memory 304 as selector data 321. The selector data 321 is a list of pointers to data on the page.

The selection module further stores the path data 320 in the memory 304.

The acquisition module 322 further includes a mapping module 326 for classifying a type for each event datum 312. Classifying the type for each event datum 312 may proceed by receiving further user input as to what type of event data 312 (e.g., title data 314) the selected element on the page corresponds to. The mapping module 326 may map the selected element multiple times, e.g., in response to user feedback that a mapping is not correct, the mapping module 326 may receive further user input as to what type of event data 312 to map to. In an embodiment, the mapping module 326 automatically maps the selected element to the event data 312 (e.g., to the title data 314).

Because of the difference between “what you see” vs. “what you get”, the underlying structure of a webpage as written (e.g., in HTML) may differ significantly from the appearance of the webpage as viewed by a user, such as a user of the user device 18 of FIG. 1. Accordingly, a user may not be able to easily select a desired element on the webpage, or a desired element may be nested inside a container or other element not desired to be selected.

When a user inputs selector data 321, a navigation structure 328 is stored in the memory 304 corresponding to the entire path of the selected element on the page.

The acquisition module 322 further includes a navigating module 330 for navigating ‘up’ or ‘down’ the navigation structure 328 (e.g., to a parent or child of a previously selected element, respectively). In an embodiment, the navigation of the navigation structure 328 proceeds according to user input (e.g., via clicking an arrow). In an embodiment, the navigating module 330 is a stack, and the user device 18 is able to return to a previously selected element. For example, in the embodiment where the navigating module 330 is a stack, a user who first selects an element on the page and then selects the ‘up’ arrow and then the ‘down’ arrow will return to the previously selected element on the page (rather than to a sibling element, i.e., a different child of the same parent).

In an embodiment, the user selects the path data 320 through the navigation structure 328 in addition to or instead of selecting an element on the webpage through the selection module 324.

In an embodiment, the user modifies the path data 320 as selected by the selection module 324 and/or the navigating module 330, by manually modifying or typing the path data 320. CSS or Xpath may be used to acquire or generate the path data 320. In an embodiment, where one out of CSS and Xpath is not available or not working on the page, the user seamlessly transitions to using the other.

Once the desired element has been selected through the selection module 324, the navigating module 330, and/or modifying the path data 320 as described hereinabove, the user indicates that the desired element has been so selected (e.g., by clicking a button).

The acquisition module 322 further includes a storing module 334 for storing the links 311 and the event data 312.

The links 311 may be stored as a part of the corresponding event data 312. The links 311 may be stored separately to the corresponding event data 312.

In an embodiment, each acquired event data 312 is uploaded and/or stored (e.g., to the acquiring server platform 12) immediately after acquisition.

In an embodiment, acquired event data 312 is uploaded only after all event data 312 pertaining to a particular event is acquired, whether indicated by a user or determined automatically.

In an embodiment, acquired event data 312 is uploaded only after all event data 312 available on or via the main page 309 is acquired, whether indicated by a user or determined automatically.

The processor 302 further includes an updating module 332 for updating previously acquired data, e.g., all data previously acquired from each main page 309. In an embodiment, the updating module 332 proceeds according to a manual command by a user (e.g., by clicking a button). In an embodiment, the updating module 332 proceeds to automatically update the previously acquired data (e.g., once a defined time period has elapsed, on a recurring basis).

The updating module 332 updates the previously acquired data by following every link 311 from the main page 309 and reacquiring each element within the event data 312 according to the path data 320 previously associated with each element of the event data 312.

For example, in respect of event data 312a, the updating module 332 follows the associated link 311a and arrives at the previously visited page (not shown) storing the event data 312a. The updating module 332 navigates to the path data 320a corresponding to each of the title data 314a, the description data 316a, the date data 317a, and the other data 318a. Where the presently stored information is identical to the previously stored information, no further action is taken. Where the presently stored information is different to the previously stored information, the previously stored information is updated to or overwritten by the presently stored information. Some but not all of the event data 312a may be out of date in that the presently stored information does not match the previously stored information for some but not all of the title data 314a, the description data 316a, the date data 317a, and the other data 318a. Where some but not all of the event data 312a is out of date, only that event data 312a that is out of data is updated (e.g., the title data 314a may be updated, but the description data 316a may not be updated).

In an embodiment, the updating module 332 automatically deletes the event data 312a where there is no presently stored information with which to compare the previously stored information. The updating module 332 may automatically select or flag the event data 312a for deletion but proceed upon receiving user permission to delete the event data 312a.

In an embodiment, a user manually deletes the event data 312a where there is no presently stored information with which to compare the previously stored information.

The updating module 332 may flag, highlight, or otherwise indicate event data 312 (e.g., the title data 314) and/or the corresponding event where the event data 312 (e.g., the title data 314) has been updated. The updating module 332 may flag, highlight, or otherwise indicate event data 312 (e.g., the title data 314) and/or the corresponding event where the event data 312 (e.g., the title data 314) has not been updated.

Accordingly, the updating module 330 advantageously updates previously acquired data en masse, e.g., via a batch process.

The updating module 330 may update in a non-batch fashion, e.g., updating only a single event. In the context of other types of structured hierarchical data, the updating module 330 may update a defined subset of the structured hierarchical data, e.g., only one or more components of a database but not the entire database.

The computer system 300 may transfer data to a standardized database, e.g., on the server platform 12, for a software application.

In an embodiment, the computer system 300 is a plug-in deployed on a browser operating on the user device 18, on the server platform 12, or on the hosting server platforms 14, 16. The computer system 300 as a plug-in may be built locally in the browser. The computer system 300 as a plug-in is loaded within the main page 309. Every time a user clicks on the plug-in within the main page 309, the plug-in may be rebuilt and may run locally on the browser. All parsing and further operation on the event data 312 may be performed at the server platform 12, on the hosting server platforms 14, 16, or elsewhere on the user device 18. All parsing and further operation on the event data 312 may be performed locally on the browser.

Many conventional browsers disapprove of adding code into a website, and so the embodiment where the computer system 300 is a plug-in or extension advantageously overcomes this disadvantage.

The acquisition module 322 may use SELENIUM™ to acquire the data by screen-scraping.

In an embodiment, the acquisition module 322 scrapes the main page 309 by opening up a plurality of headless browser instances (not shown), e.g., up to 15 at a time. The headless browser instances lack a user interface. The headless browser instances each navigate to a (different) link 311, load the page linked thereto, and use the selector data 321 to obtain the event data 312 and elements thereof (e.g., the title data 314). The browser instances are multi-threaded (e.g., updating 15 websites at a time). Such multi-threading may advantageously make the acquisition module 322 more efficient, as websites take time to load, and working in batches of, e.g., 15 websites at a time, is faster. Nevertheless, each main page 309 has a single thread, but different main pages 309 may each have an associated thread. Efficiency gains may not be further achieved where each main page 309 has its own associated thread, as the bottleneck in scraping each main page 309 is accessing the main page 309 itself. Where each event has an associated details page to access/scrape differently, such multi-threading advantageously further saves time.

It will be appreciated that the foregoing functionality of the acquisition module 322 may be applied in contexts other than events, i.e., instead of the event data 312, the acquisition module 322 may acquire other structured data.

The end user device 18 retains a copy of data uploaded in order to avoid reduplicating and re-uploading duplicated data.

In an embodiment, the updating module 332 proceeds to update at the level of each main page 309, i.e., updates all the links 311 associated with the main page 309. In the embodiment, as updating any one event data 312a associated with a link 311a on the main page 309 would involve the updating module 332 updating all event data 312 associated with all links 311 on the main page 309 in any event, the updating module 332 proceeds at the level of each main page 309.

Where known event providers and/or publishers of events (e.g., TICKETMASTER™ EVENTBRITE™) routinely host large volumes of identically or similarly formatted events on each main page 309, it may advantageously be possible to proceed even more efficiently in respect of such main pages 309. In an embodiment, after the acquisition module 322 acquires first event data 312a corresponding to a first event, that first event and associated first event data 312a may be cloned or copied so that the user device 18 only manually modifies the link 311 to refer to a subsequent event. Accordingly, the user device 18 may proceed without interfacing with the selection module 324, the mapping module 326, or the navigating module 330: because the same event data 312 may be found at the same path data 320 across identically or similarly formatted events within the same main page 309, the acquisition module 322 may proceed to automatically acquire all other event data 312 after having acquired the first event data 312a. The acquisition module 322 may proceed to acquire all other event data 312 after having acquired the first event data 312a, in response to a command received from the user.

After data is acquired according to the foregoing, the data may be rendered (e.g., by sending to the server platform 12) so that a user may visually confirm the event data 312.

Events that have occurred, or event data corresponding to events that have occurred, may be archived, for example for a period of 2 weeks after the events have occurred or after the corresponding event data 312 was acquired.

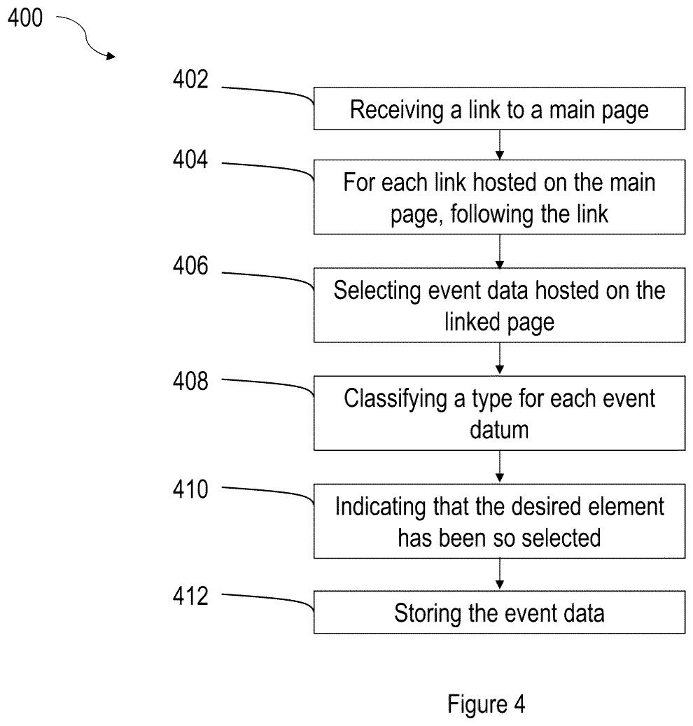

Referring now to FIG. 4, shown therein is a flow chart of a method 400 for acquiring data hosted on a server, according to an embodiment. The method 400 may be performed by the system 10 of FIG. 1 or by the computer system 300 of FIG. 3.

At 402, the method 400 includes receiving a first link to a main page. The main page includes one or more event links.

At 404, the method 400 includes, for each event link hosted on the main page, following the link to an individual event or a linked page hosting the individual event or a linked page hosting one or more event data. In an embodiment, each link on the main page links to an individual event in a bijective fashion. In an embodiment, each link on the main page links to more than one event. For example, each link may link to multiple events, but each event may only be accessible through one link. For example, each link may link to multiple events, and each event may be accessible through more than one link. The main page may include any number of links. All embodiments wherein each event is accessible through one or more links 311, each of which may link to one or more events, are expressly contemplated.

At 406, the method 400 includes, for each linked page, selecting one or more event data hosted on the linked page by selecting an element on the linked page.

Selecting the event data at 406 may include allowing the user to manually select the element on the page through the use of a selector.

Selecting the event data at 406 may include receiving user input for navigating ‘up’ or ‘down’ the navigation structure of the page (e.g., the HTML syntax tree of the webpage).

Selecting the event data at 406 may include modifying path data as selected by manually modifying or typing the path data.

At 408, the method 400 includes receiving user input to classify a type for each event datum. Receiving user input to classify the type for each event datum may include receiving the user input as to what type of event data (e.g., title data) the selected element on the page corresponds to.

At 410, the method 400 includes indicating that the element has been correctly selected (e.g., by clicking a button).

At 412, the method 400 includes storing the event data.

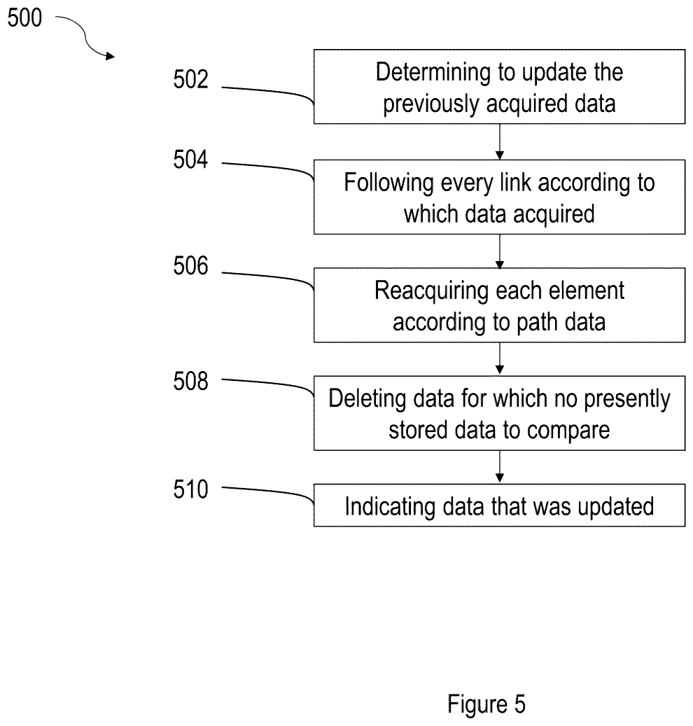

Referring now to FIG. 5, shown therein is a flow chart of a method 500 for updating previously acquired data hosted on a server, according to an embodiment. The method 500 may be performed to update data previously acquired according to the method 400 of FIG. 4. The method 500 may be performed by the system 10 of FIG. 1 or by the computer system 300 of FIG. 3.

At 502, the method 500 includes determining to update one or more of the previously acquired data. Each previously acquired datum was previously acquired via following a corresponding event link on a main page. The determination may be made according to a manual command by a user (e.g., by clicking a button). The determination may be made automatically (e.g., once a defined time period has elapsed, on a recurring basis).

At 504, the method 500 includes following each corresponding event link according to which the previously acquired data was acquired.

For example, in respect of event data 312a, at 504 the associated link 311a is followed to arrive at the previously visited page storing the event data 312a

At 506, the method 500 includes reacquiring each previously acquired datum according to path data previously associated with an element on the linked page. The element was previously selected as the event datum.

For example, the path data 320a corresponding to each of the title data 314a, the description data 316a, the date data 317a, and the other data 318a is used to reacquire the title data 314a, the description data 316a, the date data 317a, and the other data 318a, respectively. Where the presently stored information is identical to the previously stored information, no further action is taken. Where the presently stored information is different to the previously stored information, the previously stored information is updated to or overwritten by the presently stored information. Some but not all of the event data 312a may be out of date in that the presently stored information does not match the previously stored information for some but not all of the title data 314a, the description data 316a, the date data 317a, and the other data 318a. Where some but not all of the event data 312a is out of date, only that event data 312a that is out of data is updated (e.g., the title data 314a may be updated, but the description data 316a may not be updated).

At 508, the method 500 further includes automatically deleting each previously acquired datum for which there is no element on the linked page corresponding to the element previously selected as the event datum.

In an embodiment, the method further includes a user manually deleting the event data 312a where there is no presently stored information with which to compare the previously stored information.

At 510, the method 500 further includes flagging, highlighting, or otherwise indicating data that was updated (i.e., previously acquired data whose value has changed according to the presently stored information) as such.

In an embodiment, data that was not updated is further flagged, highlighted, or otherwise indicated as such to differentiate data that was not updated from data that was updated.

In an embodiment, data that was not updated is not further flagged, highlighted, or otherwise indicated as such so that the flagging, highlighting, or other such indications of the data that was updated distinguish the data that was not updated from the data that was updated.

Flagging, highlighting, or otherwise indicating any of the foregoing data may include providing a log for recording any one or more of data deleted at 508; updated data flagged, highlighted, or otherwise indicated at 510; and non-updated data flagged, highlighted, or otherwise indicated at 510.

The previous acquisition of data, e.g., according to the method 400, and/or the updating of previously acquired data according to the method 500 may include screen-scraping.

Advantageously, the method 500 updates previously acquired or scraped data en masse, e.g., via a batch process.

The method 500 may further include transferring data to a standardized database, e.g., on the server platform 12 of the system 10 of FIG. 1, for a software application.

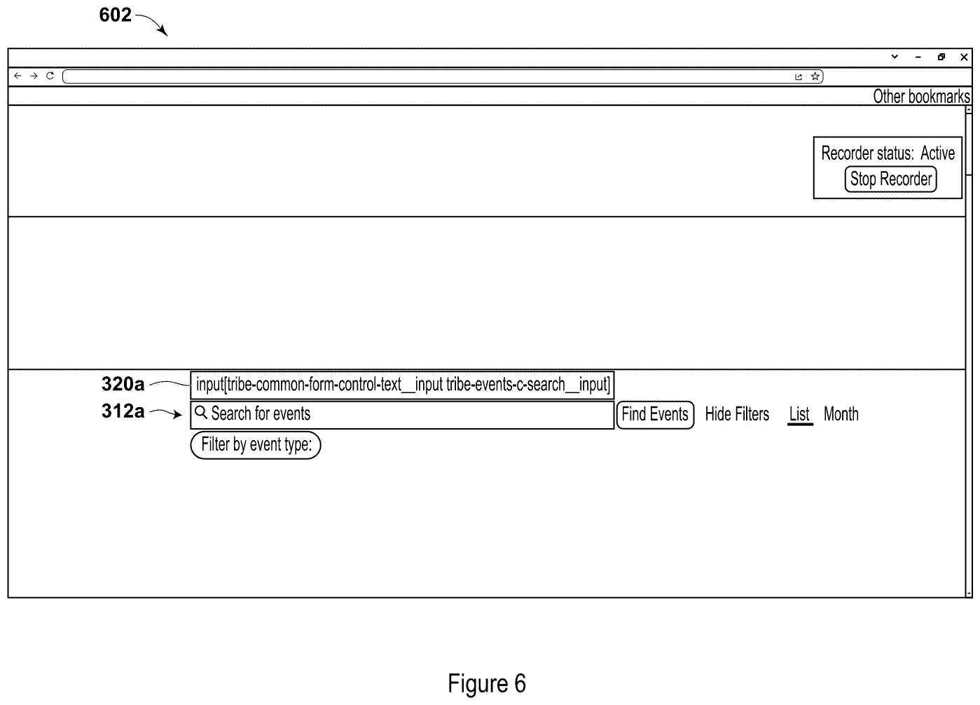

Referring now to FIG. 6, shown therein is a view of a webpage 602 during selection of an element. The selection may occur pursuant to the method 400 of FIG. 4 and/or be implemented by the computer system 300 of FIG. 3 and/or by the computer system 10 of FIG. 1.

The webpage 602 is a webpage linked to by the main page 309. The webpage 602 includes event data 312 throughout. In particular, the webpage 602 includes event data 312a, which is event data the user intends to acquire.

The event data 312a includes corresponding path data 320a. In FIG. 6, when the event data 312a is selected, the corresponding path data 320a appears as a tag or other interface element adjacent (e.g., above) the selected event data 312a. Advantageously, the user is able to see the path data 320a to determine what event data 312a has been selected.

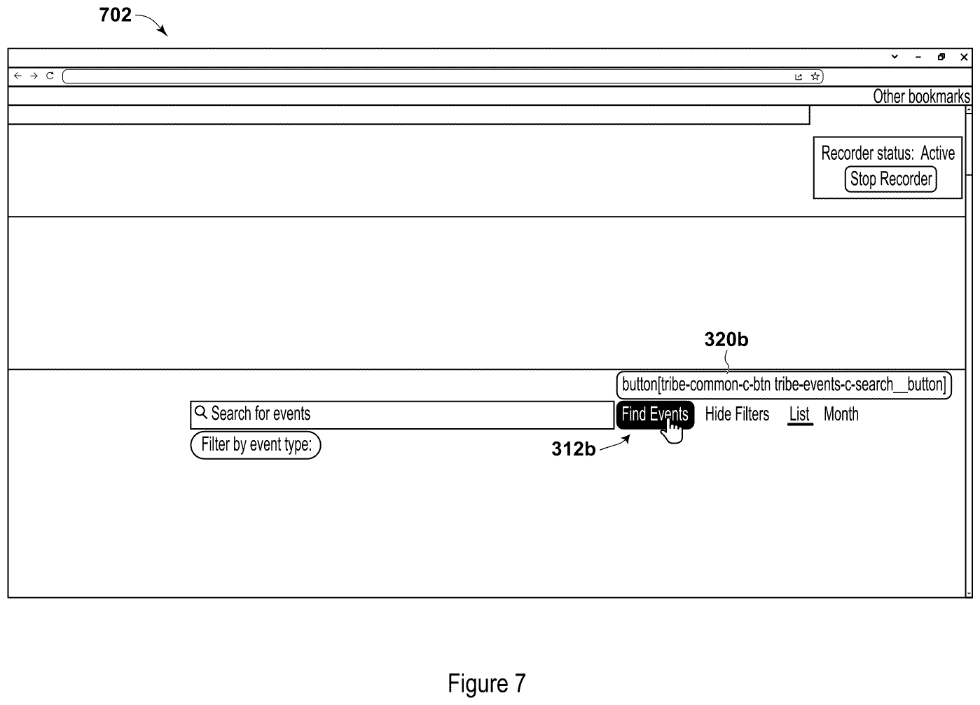

Referring now to FIG. 7, shown therein is another view of a webpage 702 during selection of an element. Identical and like numerals denote identical or like references, respectively, with respect to FIG. 6.

In particular, in FIG. 7, different event data 312b has been selected. Accordingly, different corresponding path data 320b has been displayed as a tag above the selected event data 312b.

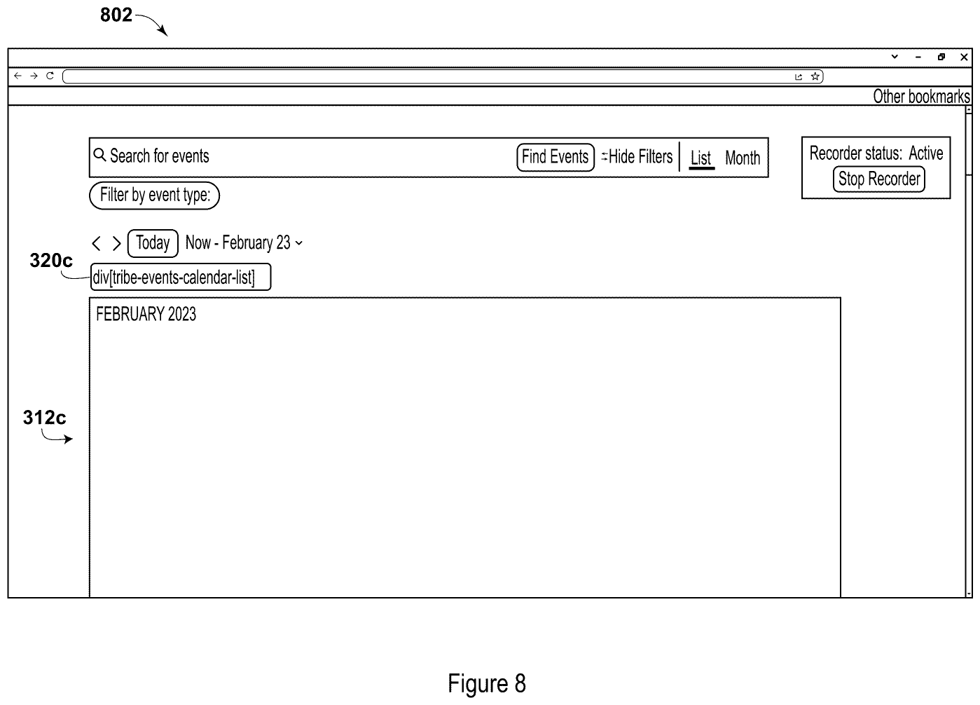

Referring now to FIG. 8, shown therein is another view of a webpage 802 during selection of an element. Identical and like numerals denote identical or like references, respectively, with respect to FIG. 6.

In particular, in FIG. 8, different event data 312c has been selected. Accordingly, different corresponding path data 320c has been displayed as a tag above the selected event data 312c.

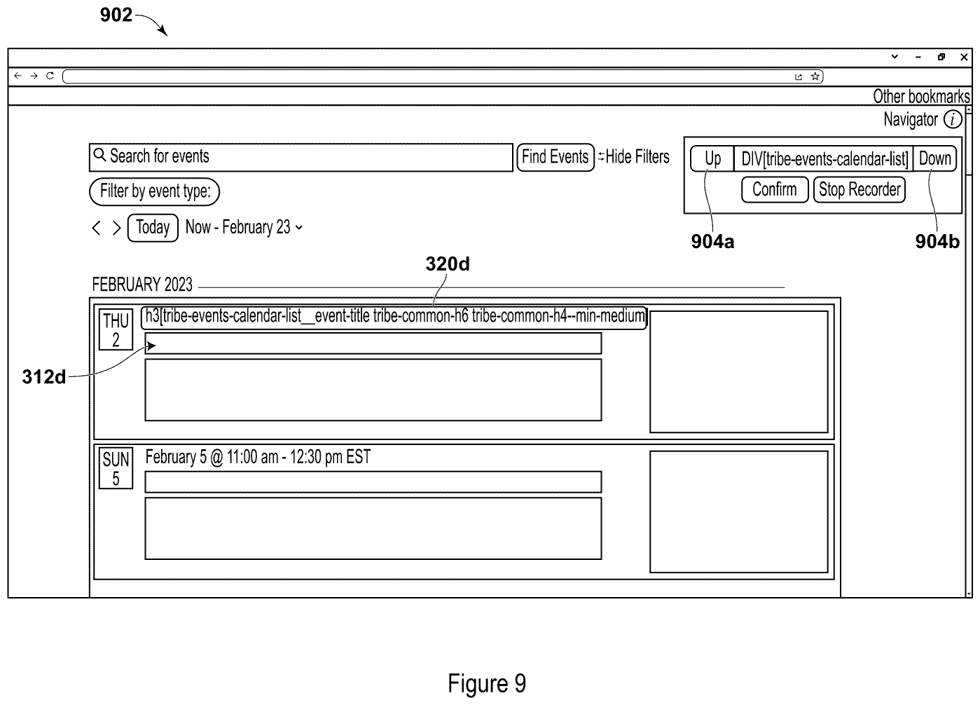

Referring now to FIG. 9, shown therein is another view of a webpage 902 during selection of an element, the navigation structure being visible. Identical and like numerals denote identical or like references, respectively, with respect to FIG. 6.

In particular, in FIG. 9, different event data 312d has been selected. Accordingly, different corresponding path data 320d has been displayed as a tag above the selected event data 312d.

The webpage 902 further includes an ‘up’ button 904a and a ‘down’ button 904b for navigating the navigation structure 328. When the ‘up’ button 904a is clicked, the previously selected element is no longer selected and a parent thereof is selected instead. When the ‘down’ button 904b is clicked, the previously selected element is no longer selected and a child thereof is selected instead.

When an element on the webpage 902 is selected, each sibling element may be similarly selected (i.e., each element with the same parent). When event data, such as the event data 312d, is selected, the event data of all sibling events may be similarly selected.

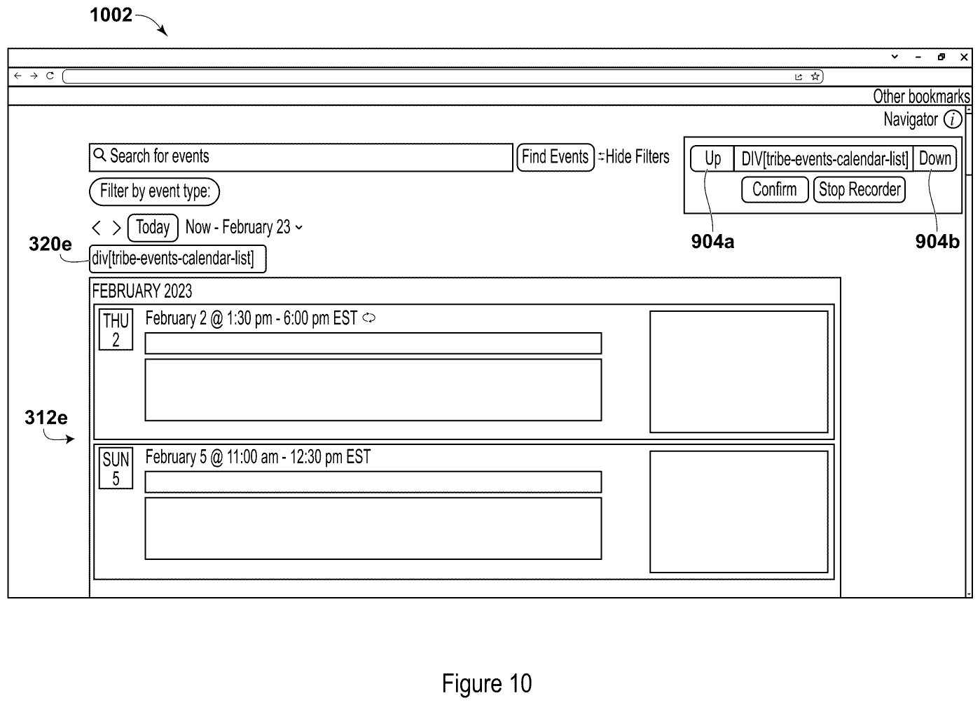

Referring now to FIG. 10, shown therein is another view of a webpage 1002 during selection of an element, the navigation structure being visible. Identical and like numerals denote identical or like references, respectively, with respect to FIG. 9.

In particular, in FIG. 10, different event data 312e has been selected. Accordingly, different corresponding path data 320e has been displayed as a tag above the selected event data 312e.

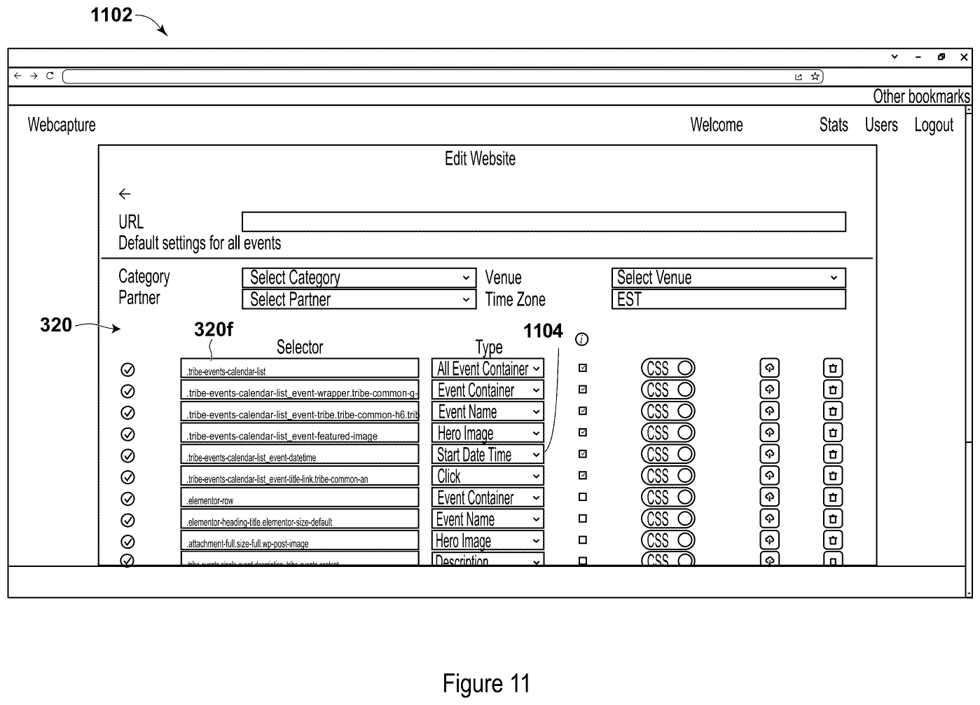

Referring now to FIG. 11, shown therein is a view of a webpage 1102 where path data corresponding to event data is modified. The webpage 1102 includes the path data 320 corresponding to event data 312 selected, e.g., as shown in any one or more of FIGS. 6-10. The path data 320 includes specific path data, e.g., path data 320f corresponding to event data 312f. In the interest of clarity, each example of path data in FIG. 11 is not labelled, but it will be appreciated that each entry shown below 320f is another example of specific path data, e.g., path data 320g, path data 320h (not shown).

The webpage 1102 further includes type data 1104 corresponding to the type of event data 312 (i.e., whether the event data 312 is title data 314, description data 316, the date data 317, or other data 318). It will be similarly appreciated that, in the interest of clarity, each example of type data 1104 in FIG. 11 is not labelled but that each entry above and below the type data 1104j is another example of the type data 1104.

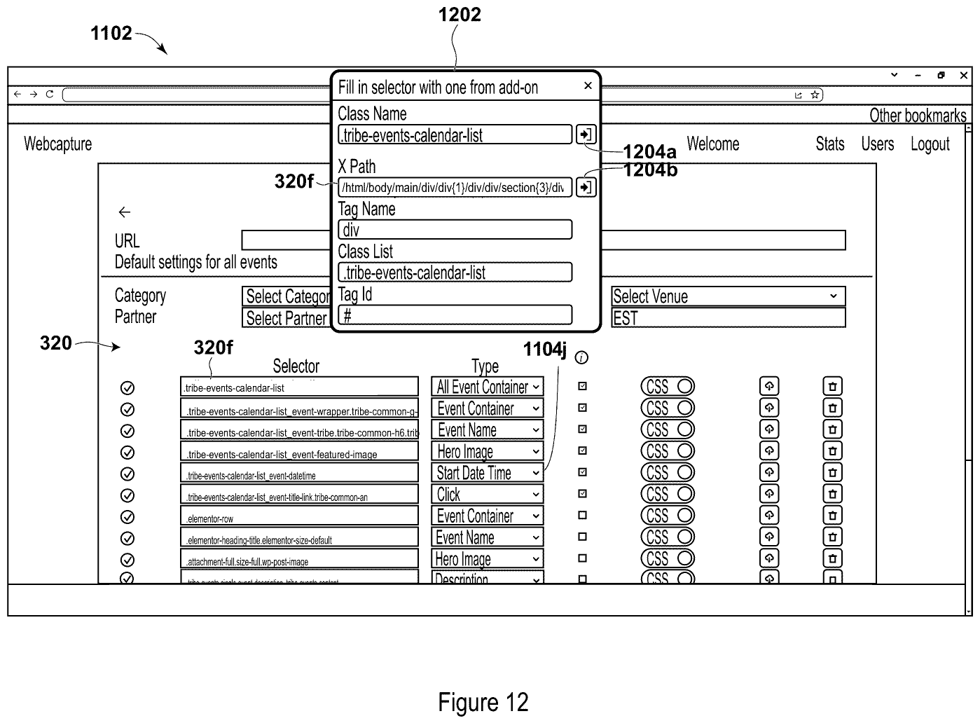

Referring now to FIG. 12, shown therein is a view of the webpage 1102 where selection of an element is being edited by modifying path data 320f. Identical and like numerals denote identical or like references, respectively, with respect to FIG. 11.

The webpage 1102 in FIG. 12 further includes a selector 1202 for editing data corresponding to the event data 312, e.g., for editing the path data 320. A user of the present invention may open the selector 1202 in order to add, alter, or delete the path data 320, e.g., the path data 320f.

The webpage 1102 further includes confirmation buttons 1204a, 1204b for verifying a selection made by the user, e.g., of the path data 320f.

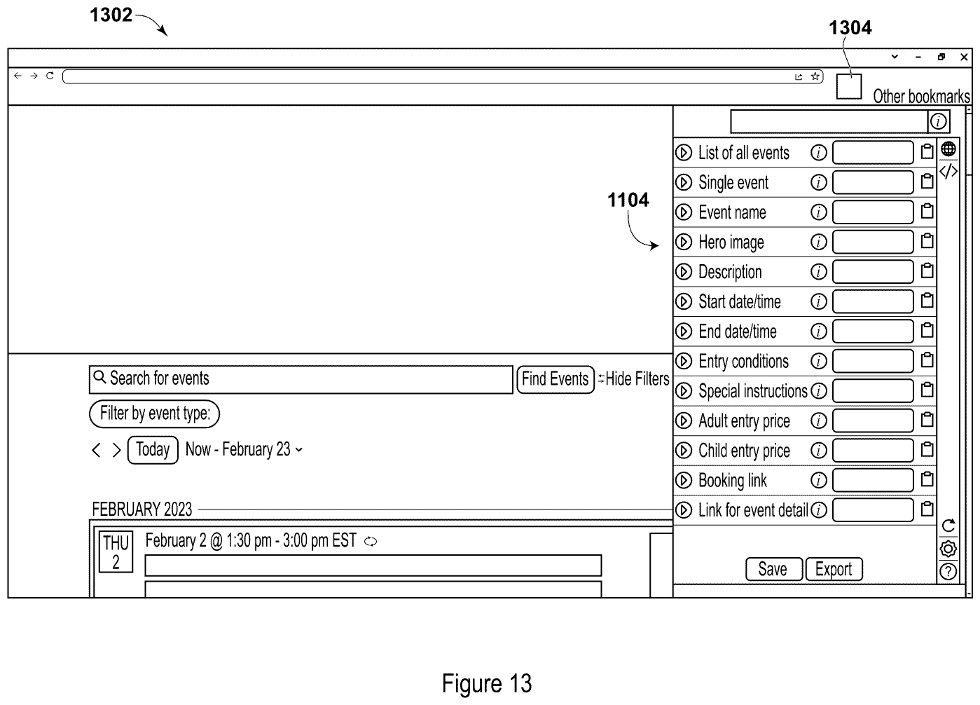

Referring now to FIG. 13, shown therein is a view of a webpage 1302 where selected elements are being mapped. Identical and like numerals denote identical or like references, respectively, with respect to FIGS. 6 and 11.

By clicking on a button or other element 1304 of the webpage 1302, a user is able to see a list of all the type data 1104 to which event data 312 corresponding to selected elements may be mapped or corresponding to which event data 312 may be selected (e.g., by selecting data elements), by operation of the mapping module 326.

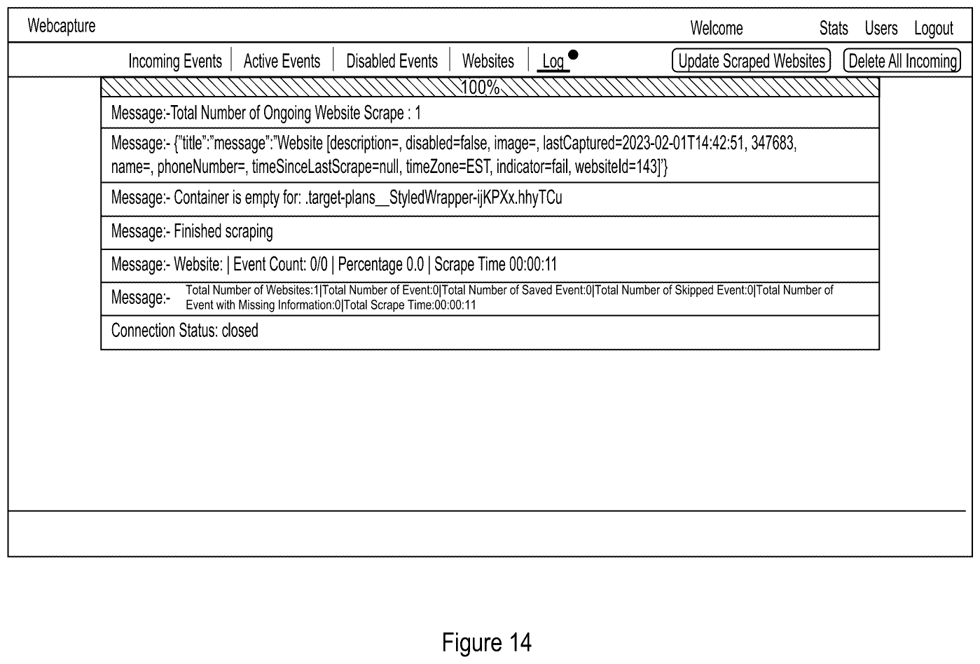

Referring now to FIG. 14, shown therein is a log of the results of attempting to update previously acquired data.

Where content on a webpage is not presented in a known format, the systems and methods of the present disclosure may inspect the webpage in order to discover relevant elements, e.g., an HTML element including or indicating a URL to an event-specific page including the event data 312. Such inspection may be automatic, e.g., in response to a determination that a particular element, such as a URL, is not immediately retrievable from the webpage. Such inspection may be in response to a command by the user. Such inspection may be performed by the user.

In order to improve efficiency and accuracy of acquisition of data from the webpage, the systems and methods of the present disclosure may perform optical character recognition (OCR) on all or part of the webpage, pages linked to thereon, and/or media (e.g., a JPEG image, a PDF) hosted, linked to, or otherwise provided on or in association with the webpage or pages linked to thereon. Performing OCR may advantageously provide greater accuracy in respect of elements that appear on the webpage but that are somewhere else, e.g., embedded in a Java function.

The present disclosure includes a method of determining whether specific structured information on a web page has changed. Such method proceeds by using a changed status of the structured information to update or skip updating such structured information in a database.

The present disclosure includes a method of transforming data from an HTML data source with several possible information organizational structured into a single or uniform structure. For example, transforming HTML tags to a uniformly structured database format.

The foregoing disclosure applies to all suitable types of structured data beyond event data. For example, the foregoing disclosure may be applied to other types of structured data including names, products, descriptions, serial numbers, addresses, cargo, and financial information.

1. A computer system for acquiring structured data hosted on a server, the system comprising:
an acquisition module for acquiring the structured data from one or more linked pages each linked to from a main page by a page link by following each page link, the acquisition module comprising:
a selection module for selecting one or more structured data hosted on the linked page by selecting an element on the linked page and storing path data corresponding to the selected element;
a mapping module for classifying a type for each structured datum;
a navigation module for navigating a navigation structure of each linked page to vary a selection of each element; and
a storing module for storing the page links and the structured data; and
an updating module for updating the structured data according to the stored path data.

2. The computer system of claim 1, wherein the structured data is event data pertaining to one or more events having a definite time, duration, or place.

3. The computer system of claim 1, wherein the selection module receives selector data to navigate the linked page.

4. The computer system of claim 1, wherein the acquisition module acquires the data through screen-scraping.

5. The computer system of claim 4, wherein the screen-scraping includes:
opening up a plurality of headless browser instances lacking a user interface;
wherein each headless browser instance is configured to:
navigate to a page link;
load the page linked by the page link; and
use the selector data to obtain the event data.

6. The computer system of claim 1, wherein the updating module does not update the structured data where the structured data has not changed.

7. The computer system of claim 2, wherein each event datum corresponds to an event and includes at least one of a title of the event, a description of the event, and a date or time of the event, and the page link, and wherein the path data stores a path on the linked page for the title of the event, the description of the event, the date or time of the event, and/or the event link.

8. The computer system of claim 1, wherein the structured data of the one or more linked pages includes HTML data stored in a plurality of formats or organizational structures, and wherein the storing module stores the structured HTML data according to a uniform database format.

9. A computer-implemented method for acquiring structured data hosted on a server, the method comprising:
receiving a first link to a main page, the main page comprising one or more page links;
for each page link, following the page link to a linked page;
for each linked page, selecting one or more of the structured data hosted on the linked page by selecting an element on the linked page;
for each selected structured datum, storing corresponding path data;
classifying a type for each structured datum;
indicating that the element has been correctly selected; and
storing the structured data.

10. The computer-implemented method of claim 9 further comprising scraping the main page by opening up a plurality of headless browser instances, each headless browser instance navigating to a respective page link and loading the respective linked page.

11. The computer-implemented method of claim 9, wherein the structured data is event data pertaining to one or more events having a definite time, duration, or place.

12. The computer-implemented method of claim 9, wherein the structured data of the one or more linked pages includes HTML data stored in a plurality of formats or organizational structured, and wherein storing the structured data includes storing the structured HTML data according to a uniform database format.

13. A computer-implemented method for updating previously acquired structured data hosted on a server, the method comprising:
determining to update one or more of the previously acquired structured data, each previously acquired structured data having been acquired via following a corresponding page link on a main page to a linked page;
following each corresponding page link;
reacquiring each previously acquired structured datum according to path data previously associated with an element on the linked page, the element having been previously selected as the structured datum;
automatically deleting each previously acquired structured datum for which there is no element on the linked page corresponding to the element previously selected as the structured datum; and
indicating which data were updated.

14. The computer-implemented method of claim 13 further comprising scraping the main page by opening up a plurality of headless browser instances, each headless browser instance navigating to a respective event link and loading the respective linked page.

15. The computer-implemented method of claim 13, wherein the structured data is event data pertaining to one or more events having a definite time, duration, or place.

16. The computer-implemented method of claim 13, wherein determining to update the one or more of the previously acquired structured data is performed according to received user input.

17. The computer-implemented method of claim 13, wherein determining to update the one or more of the previously acquired structured data is performed automatically.

18. The computer-implemented method of claim 13 further comprising providing a log for recording which data were deleted, which data were updated, and which data were not deleted or updated.

19. The computer-implemented method of claim 13, wherein the one or more previously acquired structured data is updated only if the one or more previously acquired structured data has changed.

20. The computer-implemented method of claim 13, wherein the structured data of the one or more linked pages includes HTML data stored in a plurality of formats or organizational structures, and wherein reacquiring each previously acquired structured datum includes storing the structured HTML data according to a uniform database format.
